(19) United States
(12) Patent Application Publication
(10) Pub. No.: US 2018/0360677 A1
(43) Pub. Date: Dec. 20, 2018

(54) EXOSKELETON WITH CAMBERED WHEELS FOR HUMAN LOCOMOTION

(71) Applicant: Gilmar José Alves de Carvalho, Florianopolis (BR)

(72) Inventor: Gilmar José Alves de Carvalho, Florianopolis (BR)

(21) Appl. No.: 15/576,714

(22) PCT Filed: Dec. 15, 2016
(86) PCT No.: PCT/BR2016/050332

§ 371 Date: Nov. 23, 2017

(30) Foreign Application Priority Data
Dec. 18, 2015 (BR) 102015031925

(51) Int. Cl. A61G 5/04; A61G 5/06; A61G 5/10; B62K 11/00; B62K 23/02; A61H 3/00

(52) U.S. Cl. CPC A61G 5/04; A61H 2201/1215; A61G 5/1054; A61G 5/1005; A61G 5/104; B62K 11/00; B62K 23/02; A61H 3/00; A61G 2203/14; A61H 2003/007; A61H 2201/5025; A61H 2201/5084; A61H 2003/001; A61H 2203/0425; A61H 2201/5064; A61G 5/061

(57) ABSTRACT

“EXOSKELETON WITH CAMBERED WHEELS FOR HUMAN LOCOMOTION”, comprises an orthosis in the form and function of exoskeleton articulated with actuators, and cambered wheels (9, 10) integrated between the lower limbs of the user for human locomotion, mainly intended for people with motor physical disabilities, being a motorized and intuitively controlled by the user (6) and by balance sensors, joystick (8), central RF (7), gyroscope, magnetometer, accelerometer, containing an inertial disk balancing system (19, 50), also has actuator to articulate the user between sitting and standing position, all systems being integrated electronically to a central control CPU (16) also covering the functions of starting, brake, steering and balance, traction control, up and down stairs.

The present invention relates to an exoskeleton, articulated by force actuators, integrated into a camber system, comprising inclined wheels between the lower limbs of the user for human locomotion, primarily intended as a prosthesis for persons with motor physical disabilities. Camber means the slope of the wheel in relation to the vertical plane, also known as camber or angle of Soup. Her (2009) defines bracing and exoskeleton as a mechanical anthropometric instrument that assists human movement.

This exoskeleton is comprised of a mechanical structure of articulated and structured body support with rigid and flexible parts that integrate anatomically with the body of the user. This exoskeleton structure is associated with an electrically powered system with wheels or conveyor belts and positioned between the lower limbs of the user to provide displacement of the apparatus.

The control of movement and direction of the device by the user is executed by means of a joystick and or position sensors. The joystick control is attached to the exoskeleton or the user's hand. The steering and displacement control of the device can also be performed by steering sensors such as gyro, accelerometer and magnetometer associated and positioned on the user's body. These sensors positioned on the head or trunk allow the user to control the direction and advancement of the device intuitively with a rotation of the head or torso.

The locomotion of the apparatus occurs through traction with the ground of two wheels or front conveyor belt positioned between the lower limbs of the user and a third rear wheel coupled to an actuator and position sensor that provide balance and stability to the apparatus forming a tripod of wheels in contact with the soil.

The position sensor of the rear wheel actuator makes a constant reading of the position of the apparatus to maintain the center of gravity of the apparatus and the user on the tripod base formed by the wheels. The rear wheel, via the actuator, can be picked up or moved towards the ground by changing the center of gravity on the base to favor movement with stability and dynamic balance on asymmetrical terrain and steps.

The apparatus also has a complementary system for the balance control composed of a disk-shaped mass that acts in high rotation generating an inertial moment that favors to maintain the apparatus in its stability.

There are many projects aimed at solving the difficulties encountered for human locomotion, especially in the accessibility for people with physical disabilities. In this sense and in the context of prior art, this patent application is pertinent on functional objectives with the patent application BR 1020130116777, the inventor being the same author of this patent application.

Patent application BR 1020130116777 relates to an orthosis composed of an exoskeleton integrated into a treadmill for human locomotion, mainly intended for people with physical motor disabilities. The relationship between the project presented in this patent BR 1020130116777 is in its application. However, in this patent application the originality of an inventive concept and a new design with innovative characteristics is defended.

The innovation of the present patent application design can be understood in its subdivisions of: exoskeleton, apparatus traction system, control system and stability and equilibrium system.

The exoskeleton integrated into the device mobilizes the joints of the ankle, knee, femoral thigh and vertebral column with only one motor system, one actuator. In addition to differentiated features, the design favors for lower construction costs with reduction of components employed, simplification of processes, favored ergonomics and energy saving.

The traction system has its differentiated design because the wheels or traction belts are parallel and in cambered between the lower limbs of the user. The project relating to patent application BR 1020130116777 has the configuration of wheels or belts configured parallel without camber and positioned externally and laterally to the lower limbs. This last feature shows a great difference between the present patent application and the patent application BR 1020130116777.

The balancing system design relating to patent application BR 1020130116777 is configured to act to maintain the center of gravity of the exoskeleton and user on the base of the apparatus by moving only the exoskeleton and the user relative to its traction platform. While the present patent application, the design contemplates a wheel positioning adjustment, which consequently keeps the whole apparatus and the user with the center of gravity on its base. Another difference of project related to stability can be perceived in the configuration of a system with three wheels, one being retractile. The balance control is also aided by a disk system that generates inertia force to maintain stability.

Among the principal constructive differences with respect to other designs as described in U.S. Pat. Nos. 4,124,026 and 2,110,01041A1. U.S. Pat. Nos. D735,608, 282,889, U.S. Pat. No. 911,4843, US20020170754, U.S. Pat. No. 5,701,965 and U.S. Pat. No. 8,830,048 are: of three compacted wheels between the lower limbs of the user, being two wheels of traction or belts inclined between the lower limbs in an angle that favors greater base to the apparatus and ergonomics for the positioning of the user.

A distinct feature of the present application is the configuration of cambered wheels designed to bridge small obstacles, steps, down and up stairs. As such, these design features are not presented in the patent designs cited. The design differential in relation to balance and stability lies in an integrated actuator the rear wheel with position sensors. Another main design differential is the exoskeleton structure that keeps the user attached to the device. The exoskeleton of the present application is understood as a motorized orthosis which integrates with the user's body with actuating systems which articulate and displace the user's body by means of inclined wheels.

The concept of using a disk or flywheel with inertial momentum or gyroscopic precession force is also known in other designs such as patent Nos. U.S. Pat. No. 9,144,526B2 and US2011/0231041A1.

However, in this present patent application, the equilibrium control is favored by a simple inertial moment of a disk-shaped mass in high rotation, without using control mechanisms that result in the control of the balance by force or precession effect. In the patents referenced, U.S. Pat. No. 9,144,526B2 and US2011/0231041A1, the balance is managed by means of a gyroscopic system with disks that cause the force or precession effect. And by this force the balance of the apparatus is controlled.

Therefore, the technology described in the present patent application is not utilized by the gyroscopic precession effect, but rather by the inertial moment of a high rotation disc. This system of the present patent application does not allow adjustments of position resulting from the inertial system. The system only creates a moment of inertia that opposes the destabilization of the device. In addition, a gyroscopic counterbalance force system with a precession equilibrium effect requires high energy expenditure, which would make it difficult to apply to smaller devices.

The stability and balance of the apparatus of the present application are provided primarily by a position-sensing actuator that controls the pick-up or extension of the rear wheel relative to the ground. As the rear wheel is extended or displaced relative to the ground, support point, a rotation of the apparatus occurs around the axis of the two front wheels positioned between the lower members of the user. In this way, the balance is automatically monitored and adjusted by sensors for the transposition of obstacles and uneven terrain.

In the state of the art related to exoskeleton there are orthoses with robotic joint system that favor for the displacement, support and user gait. These include: Berkeley Bionicso (USA), Dubbed Rex from Rex Bionics, Walk Assist (made by Honda), Robo Knee, Hal, ReWalk and Blex. Reference is also made to the robotic and non-robotic patents: US20130158445, US20130158445, US20130102935, US20140100493, US20070123997, U.S. Pat. No. 7,731,670, U.S. Pat. No. 8,057,410, U.S. Pat. No. 9,095,981. As known, these orthoses promote the articulation of the lower limbs and the support of the user's body for the displacement by means of walking, walking.

While the design presented in the present application, the displacement occurs by the traction of wheels or belts in cambered, being an articulated vehicle with wheels in the form and function of an exoskeleton.

In the patent application BR 1020130116777, the same author of the present patent application, it is mentioned that an exoskeleton system integrated to a wheel or treadmill system can fill a gap between the wheelchair and the robotic exoskeleton. Especially when it comes to agility for mobility and cost of manufacturing.

The description of the following figures is given by way of example and illustration for a better understanding of the object of the present application.

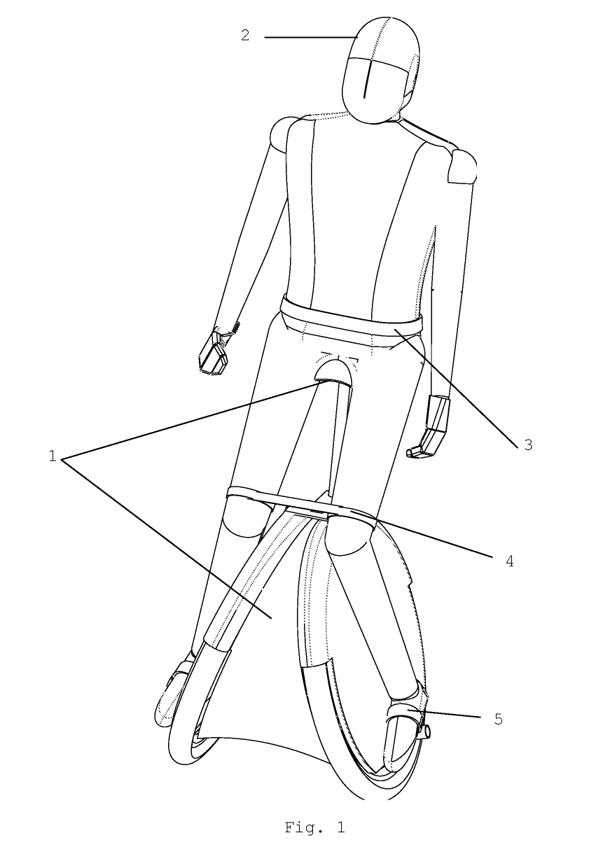

FIG. 1 shows the Camber Exoskeleton with swiveling wheels 1 with a user 2 in the standing position secured to the apparatus by a belt on the hip 3, a knee strap 4 and foot straps 5.

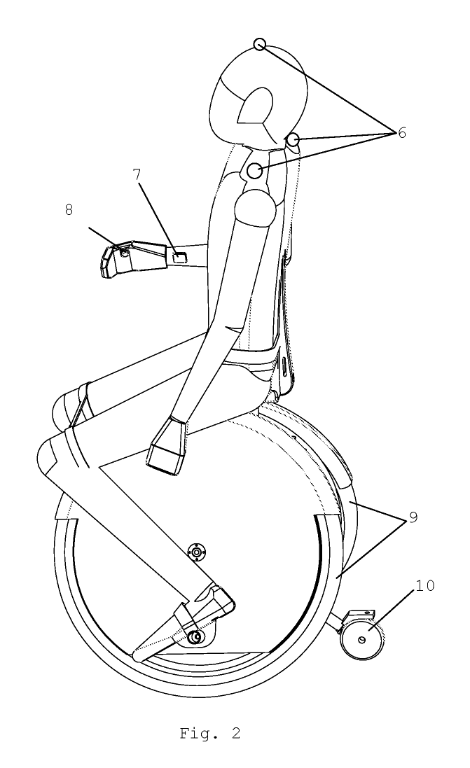

FIG. 2 shows the user (2) in the sitting position in the Camber Exoskeleton (1), the steering control system (6, 7 and 8), being sensors of direction (6), RF control center (7) and joystick (8) with front wheel drive in cambered (9) and rear wheel (10).

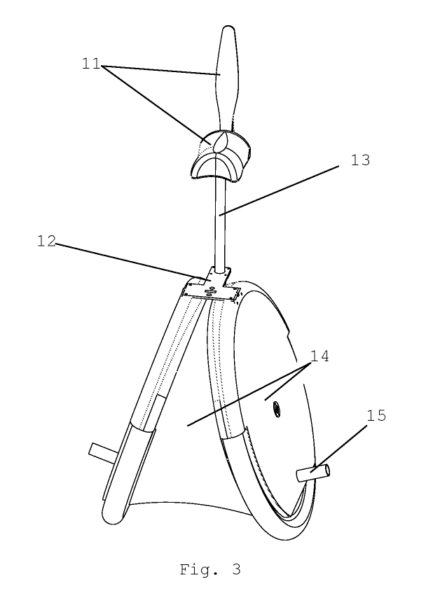

FIG. 3 shows the main external components of the Camber Exoskeleton: seat (11), seat screw spindle (13), spindle guide plate (12), fairing (14) and pedal (15).

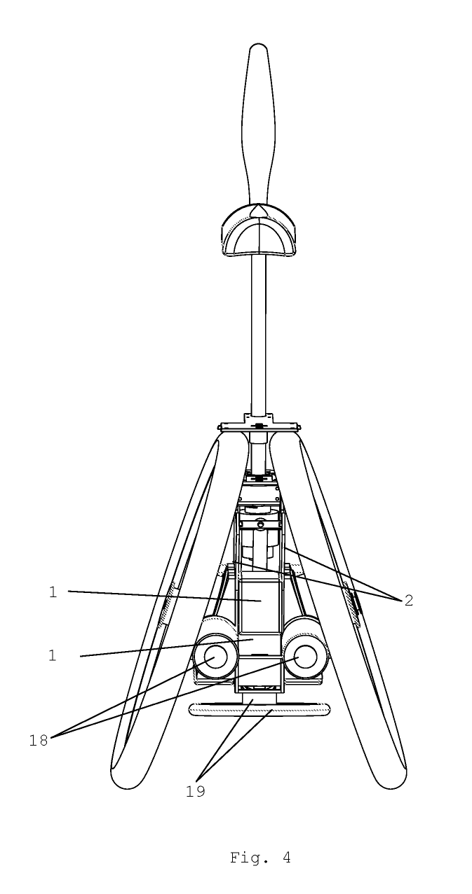

FIG. 4 shows in the frontal plane the arrangement of components and parts of the Camber Exoskeleton (1): CPU—Central Processing Unit (16), inertial motor (17) traction motors (18), inertial balance system parallel to the chassis (20).

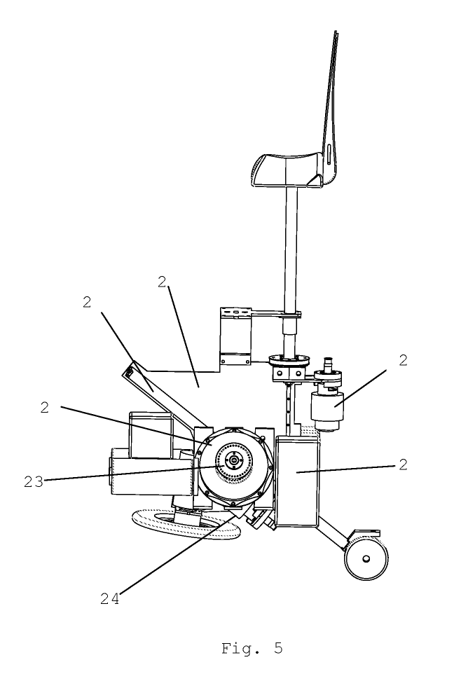

FIG. 5 illustrates in the right side plane the arrangement of components and parts of Camber Exoskeleton 1: parallel plate of chassis 20, spindle of actuator wheel 21, cycloidal gearmotor 22, traction wheel hub 23, motor rear wheel actuator (24), motor actuator seat (25), battery (26).

FIG. 6 shows the actuator system of the seat 11: support rod 27, seat 28, spindle drive traction pulleys 29, spindle support cap 30, spindle drive 31, capsule bearing motor shaft (32) motor actuator bench (25).

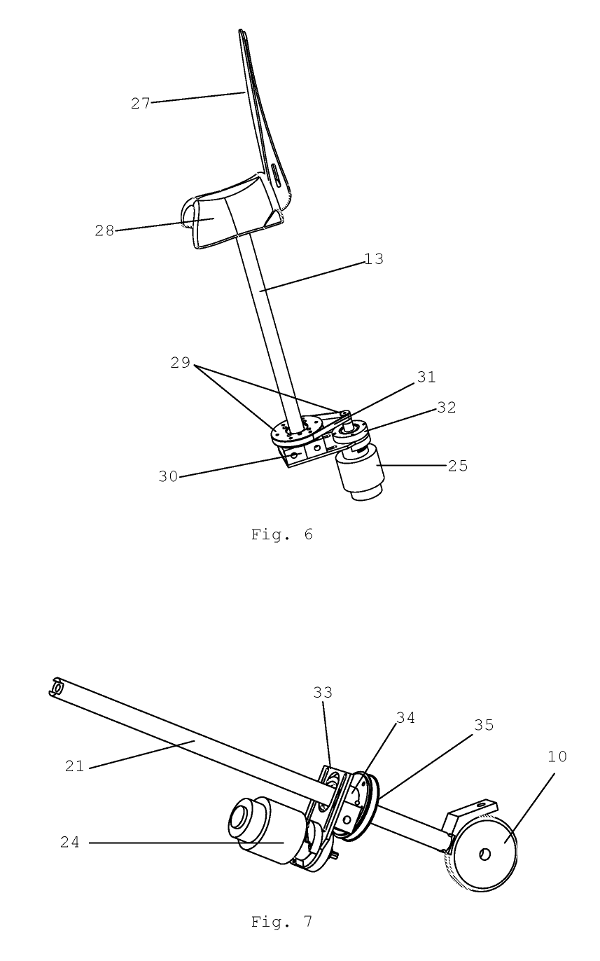

FIG. 7 shows the actuator system of the rear wheel 10: actuator spindle wheel 21, rear wheel actuator motor 24, spindle motor support plate 33, spindle nut 34, spindle wheel pulley (35) and rear wheel (10).

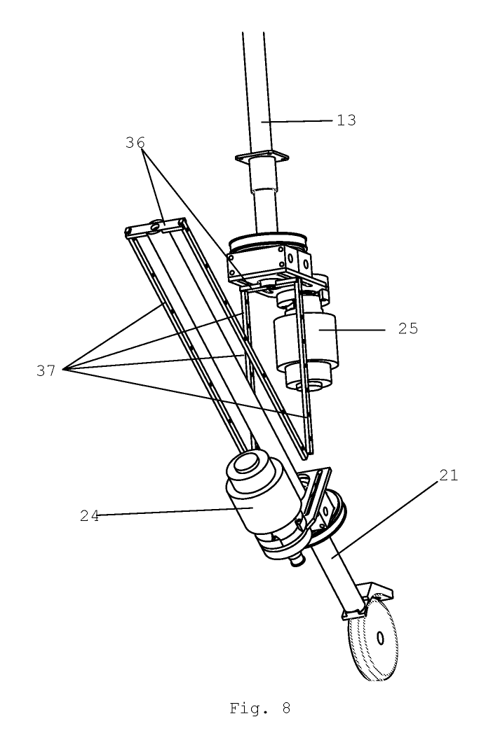

FIG. 8 shows the stem spindle 36, spindle guides 37, rear wheel actuator motor 24, seat actuator motor 25, seat actuator spindle 13, spindle of the wheel actuator 21.

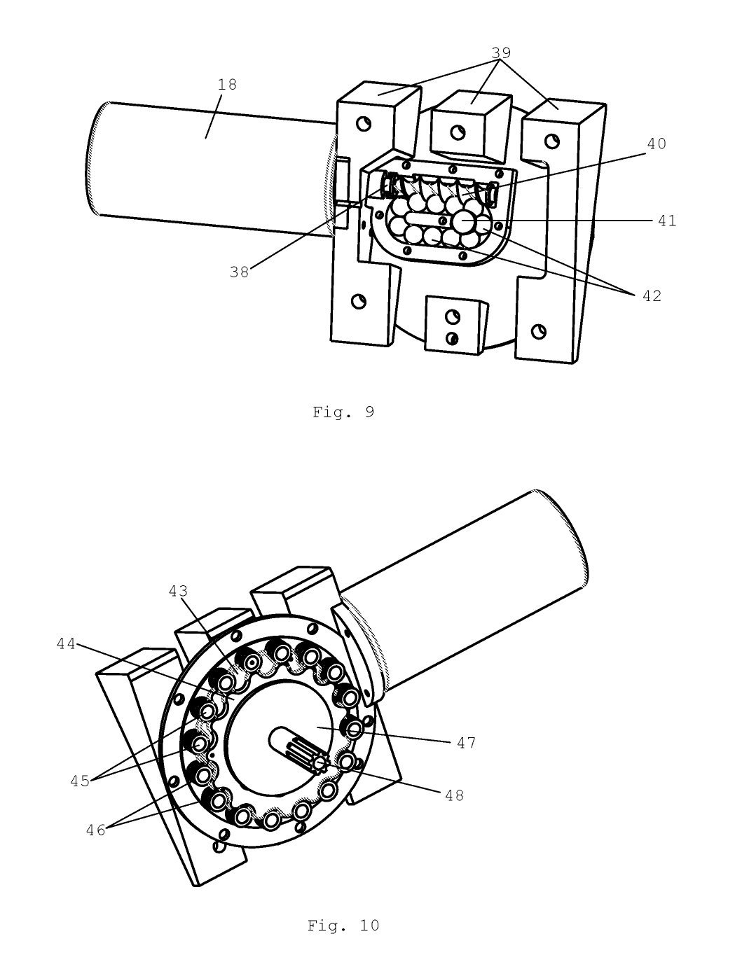

FIG. 9 shows the internal parts and components of the cycloidal geared motor 22: traction motors 18, drive shaft 38, support blocks 39, torque spindles 40, input reducer shaft 41, torque bearing (42).

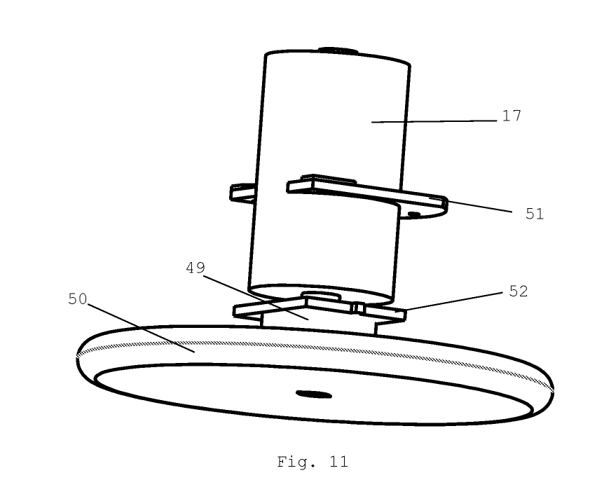

FIG. 10 shows the internal parts and components of the cycloid gearmotor 22: clockwise cycloidal disk 43, cycloid counterclockwise disk 44, cycloidal pin 45, pin ring 46, output torque disk 47, reduction output shaft (48).

FIG. 11 shows the components of the equilibrium inertial system 19: bearing-disk capsule 49, inertial disc 50, motor support plate 51, disk support plate 52 and inertial motor 17.

With reference to the figures presented, the Camber Exoskeleton (1) object of the present application is constituted by an electric vehicle wheel system (9, 10) swung between the lower limbs and integrated with the body of the user (2). It provides the articulation of the body between the standing and sitting positions performing the function of vehicle and external skeleton of locomotion.

The user 2 attaches to the apparatus by means of straps 3, 4, that allow the stability of an individual with lower limb paralysis or even a lower limb amputee.

The Camber Exoskeleton can be controlled by the individual through a system of direction sensors (6) or joystick (8) integrated into a control center (7) RF—Radio Frequency that communicates with a CPU—Central Processing Unit 16). The CPU—Central Processing Unit (16) controls the traction motors (18), the actuator bank (FIG. 6), the rear wheel actuator (FIG. 7) and the equilibrium inertial system (Fig.

The steering sensor (6) and the control joystick (8) are electronically integrated with the CPU (16) having position sensors which provide position and acceleration orientation on the x, y, and z axes. The control of the device can be controlled by the user (2) via the direction sensor (6) or the joystick (8). The steering sensor (6) can be positioned and one of the shoulders, trunk or head. This allows intuitive control, if the user (2) turns the head or trunk to the right, the device will move to the right. If the user tilts the head or the trunk, forward or backward, the device will also follow the forward or back off command. These same forward, back off and twist commands can be carried out optionally by the mini joystick (8).

The control system of the apparatus operated by means of the joystick (8) fixed in the form of a ring in the fingers of the user's hand (2) or by means of the direction sensor (6), intuitively obeying the actions of the user (2) favors freedom of movement of upper limbs for other activities. The steering controls (6, 8) are associated with gyro, accelerometer and magnetometer sensors affixed to the electronic circuit board of the CPU (16). These CPU sensors 16 make a constant reading of the apparatus position at the x, y, and z coordinates.

The position sensors integrated in the CPU (16), in addition to providing the steering control, make it possible to control wheel traction (9), which is essential for the stability of the machine in slippery terrain and in the transposition of obstacles or steps. The traction control acts by means of the traction motors (18) and favors the traction wheels (9) advancing or retreating in a manner equalized to the user's command.

There are other control buttons integrated into the mini joystick (8) and control center (7) that allow the user (2) to stand or sitting, speed control for transposition of steps or stairs, emergency beep and on-off.

The ergonomics of the Camber Exoskeleton (1) is favored by the cambered of the wheels (9) protected by a fairing (14) which also provides support for the user's lower limbs (2) together with a foot pedal (15).

The balance and stability of the apparatus take place by means of its base formed by a three-wheeled tripod, two front traction wheels (9) and a rear wheel (10). With the moving apparatus the rear wheel (10) is pivoted according to the direction imposed by the front traction wheels (9).

The traction system is electric, with traction motors (18) being fed by batteries (26) and coupled to a cycloidal reducer (22) which extends the traction torque.

The rear wheel 10 is coupled to an actuator system (FIG. 7) with position sensors integrated into the CPU 16 which make a constant reading to maintain the center of gravity of the user and the apparatus on the tripod base formed by the three wheels (9, 10) in contact with the ground.

The rear wheel, by means of an actuator system (FIG. 7), can be collected or moved towards the ground by changing the center of gravity on the base to favor dynamic and static balance displacement on asymmetrical terrain and steps. As the rear wheel is displaced relative to the ground, bearing point, a rotation of the apparatus occurs about the axis of the two front traction wheels (9) positioned between the lower members of the user. In this way, the balance is automatically monitored and adjusted by sensors for the transposition of obstacles and uneven terrain.

The device has an actuator system for the user's seat (FIG. 6). This seat has a saddle-shaped seat (28) with small vibrating motors that can be actuated to stimulate the user's blood circulation (2). These small motors are positioned internally to the seat upholstery and the column support rod (27).

Both actuators seat and the rear wheel (FIG. 6, FIG. 7) having actuator motors (24, 25) with drive pulleys (25, 29) reducing it by means of a belt (31) pulls a ball coupling (34) by moving the spindle (21, 13) engaged.

The actuator system of the bank and the rear wheel (FIG. 6, FIG. 7) is fixed to the device by the support screw capsule (30) and guides the spindle (37) along the parallel plates of the chassis (20). The spindles (21, 13) of the actuators have spindles against spindle rotation (36) which in addition to reinforcing and stabilizing the system define a spindle actuation without rotation. The rotation occurs only in the ball nut (34) forcing the spindle (21, 13) to act linearly without rotation. This system makes it possible for an actuation to occur without the seat (11) or the rear wheel (10) turning in conjunction with the system.

The cycloidal gear motor (22) of this unit consists of two traction motor reduction steps (18) with reduction with ball spindle and the other with cycloidal drive. As FIG. 9 and FIG. 10, the drive shaft (38) connects to the Torque ball spindle (40) and the spin torque moves the ball (42) which connect the gearbox input shaft (41). The gear input shaft 41 triggers the rotation of the clockwise cycloidal disk 43 and the anticlockwise cycloidal disk 44. For each turn of the input shaft of the gear unit (41) the cycloidal discs advance in the direction of their rotation a position corresponding to the rings.

This results in a reduction of the RPM - Rotation Per Minute of the input shaft of the gear unit (41). These two cycloidal discs (43, 44) are counterclockwise, centrally rotated and supported on the rings (46) which are engaged in pins (45). The torque produced by the rotation of the clockwise cycloidal disk 43 and the counterclockwise cycloidal disk 44 is transmitted to the output torque disk 47 which in turn is connected to the output shaft of the gearbox 48. The output shaft of the reducer (48) engages the traction wheel hub (23). This cycloid gearmotor 22 is secured to the apparatus by means of support blocks 39 bolted to the parallel plate of the chassis 20.

This gearmotor system (22) associated with the position sensors of the apparatus allows a wheel traction control (9) which equalizes the wheels' advance or retreat against possible skidding or slippage.

The apparatus further comprises a complementary inertial balancing system (19) composed of a disk-shaped mass (50) rotated by a motor (17) acting in high rotation generating an inertial momentum which favors the holding of the Camber Exoskeleton (1) in its stability.

1. “EXOSKELETON WITH CAMBERED WHEELS FOR HUMAN LOCOMOTION”, characterized in that said cambered exoskeleton is comprised of an orthosis in the shape and function of exoskeleton articulated with actuators, and wheels (9, 10) with swiveling integrated between the lower limbs of the user for locomotion (6) and balance, joystick (8), central RF (7), gyroscope, magnetometer, accelerometer, (19, 50), all integrated electronically to a central control unit (16), also controlling the functions of starting, brake, varying between sitting and standing position, direction and balance, up and down stairs.

2. “EXOSKELETON WITH CAMBERED WHEELS FOR HUMAN LOCOMOTION”, according to claim 1, characterized in that the cambered exoskeleton has a human locomotion system, mainly intended for persons with physical disabilities, with articulated camber wheels and positioned between the user's lower limbs.

3. “EXOSKELETON WITH CAMBERED WHEELS FOR HUMAN LOCOMOTION”, according to claim 1, characterized in that the cambered Exoskeleton has a position control and balance control system by position sensors (6) and actuator.

4. “EXOSKELETON WITH CAMBERED WHEELS FOR HUMAN LOCOMOTION”, according to claim 1, characterized in that the cambered Exoskeleton has a force actuator system (13) which allows the user to articulate between the sitting and standing positions.

5. “EXOSKELETON WITH CAMBERED WHEELS FOR HUMAN LOCOMOTION”, according to claim 1, characterized in that the cambered exoskeleton has an inertial disc equilibrium system (19, 50).

6. “EXOESQUELETO CAMBER OF WHEELS FOR HUMAN LOCOMOTION” according to claim 1, characterized in that the Camber Exoskeleton has a cycloidal geared motor (22) with torque spindle and balls (40, 42) for the traction of the wheels (9).

7. “EXOESQUELETO CAMBER OF WHEELS FOR HUMAN LOCOMOTION” according to claim 1, characterized in that the camber exoskeleton has a system for fixing and positioning the user in the apparatus with a seat (28) in the anatomical saddle shape.

8. “EXOESQUELETO CAMBER OF WHEELS FOR HUMAN LOCOMOTION”, according to claim 1, characterized in that the Camber Exoskeleton has a joystick control system (8) with RF control panel (7) which allows control of the apparatus remotely.

9. “EXOESQUELETO CAMBER OF WHEELS FOR HUMAN LOCOMOTION”, according to claim 1, characterized in that the Exoesqueleto Camber has a system of control of traction of the wheels in camber.
